(19) United States
(12) Patent Application Publication
(10) Pub. No.: US 2015/0294251 A1
(43) Pub. Date: Oct. 15, 2015

(54) DISTRIBUTED TASK SCHEDULING USING MULTIPLE AGENT PARADIGMS

(71) Applicant: NEC Europe Ltd., Heidelberg (DE)

(72) Inventors: Hanno Hildmann, Heidelberg (DE); Miquel Martin Lopez, Heidelberg (DE)

(73) Assignee: NEC Europe Ltd., Heidelberg (DE)

(21) Appl. No.: 14/250,470

(22) Filed: Apr. 11, 2014

(51) Int. Cl. G06Q 10/06

(52) U.S. Cl. CPC G06Q 10/06311

(57) ABSTRACT

A computer-implemented method for assigning tasks to a plurality of agents includes determining, by a processor, a stance for an agent of the plurality of agents; and, when an unassigned task is available, assigning, by the processor, the unassigned task to an agent in the second stance. The stance is selected from the group consisting of a first stance and a second stance. Determining the stance is based on whether an unassigned task is available. The first stance relates to balancing tasks among the plurality of agents and the second stance relates to maximizing an amount of tasks assigned to a subset of the plurality of agents.

### BACKGROUND

Scheduling and task management is a wide field and applicable to a large number of commercial endeavors. Often, the algorithms used for scheduling and assignment of tasks to multiple agents, such as persons or machines, are unable to adapt to changing conditions and/or are unable to efficiently and optimally utilize agent resources. These conventional techniques typically rely on standard optimization algorithms, and require a recalculation of the entire schedule upon the occurrence of an environment-changing event.

### SUMMARY

Embodiments of the invention provide advantageous solutions to task assignment and scheduling issues, particular suitable for situations involving large numbers geographically-distributed tasks and agents subject to changing conditions (such as the addition/removal of tasks and agents).

In an embodiment, the invention provides a computer-implemented method for assigning tasks to a plurality of agents. The method includes determining, by a processor, a stance for an agent of the plurality of agents. The stance is selected from the group consisting of a first stance and a second stance. Determining the stance is based on whether an unassigned task is available. The first stance relates to balancing tasks among the plurality of agents and the second stance relates to maximizing an amount of tasks assigned to a subset of the plurality of agents. When an unassigned task is available, the processor assigns the unassigned task to an agent in the second stance.

### BRIEF DESCRIPTION OF THE SEVERAL VIEWS OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a block diagram that illustrates an exemplary task management environment.

FIG. 2 is a flowchart illustrating a scheduling process in an exemplary embodiment.

FIG. 3 is a flowchart illustrating an individual agent cycle of the scheduling process in an exemplary embodiment.

FIG. 4 is a flowchart illustrating a check capacity stage of an agent cycle in an exemplary embodiment.

FIG. 5 is a flowchart illustrating a determine stance stage of an agent cycle in an exemplary embodiment.

FIG. 6 is a flowchart illustrating determine action and modify schedule stages of an agent cycle in an exemplary embodiment.

### DETAILED DESCRIPTION

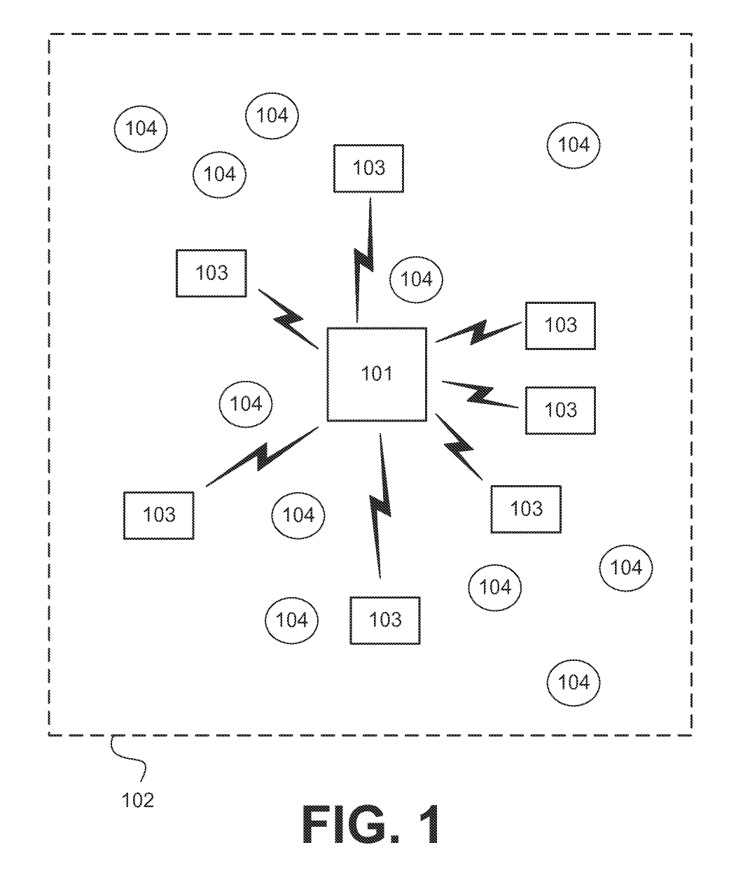

Before discussing the details of the invention, a general description of an exemplary environment in which embodiments of the invention are applicable is provided with respect to FIG. 1. FIG. 1 illustrates a task management system 101 responsible for assignment and/or scheduling of tasks throughout the geographic region represented by dotted box 102. Within the geographic region are a plurality of agents 103, which are in communication with the task management system 101. FIG. 1 further illustrates that a plurality of tasks 104 associated with particular locations within the geographic region 102 are to be assigned to the various agents 103 by the task management system 101.

The general environment illustrated in FIG. 1 may be representative of a variety of practical scenarios. In one example, the agents 103 could be surveillance drones being assigned to various surveillance tasks 104. In another example, the agents 103 are delivery trucks responsible for delivering newspapers to various neighborhoods, with delivery corresponding to a particular neighborhood corresponding to a task 104. In yet another example, the agents 103 are service engineers sent forth to perform repairs, with each repair assignment corresponding to a task 104. A non-exhaustive list of exemplary contexts in which embodiments of the invention may be used is provided as follows:
Scheduling service personnel for daily routes—in this context, the tasks are service tasks and the transitions between tasks involve a cost of moving from task to tasks. Scheduling issues that arise in this context include: changing numbers of service tasks and service personnel; time, material, or other factors related to operational costs of one or more service tasks; and maximum and/or ideal work times for service personnel (e.g., a schedule may include two constraints: a maximum not-to-exceed work time and minimization of divergence from the ideal work time).
Scheduling of emergency response units operating in disaster scenarios where the infrastructure may be failing and or subjected to dramatic changes.
Safety or security patrol scheduling capable of reacting to incidents or triggers that require attention. In this case, a finer-grained patrolling scheme and/or an increased staff allocation can be achieved by scheduling additional events (e.g. checkpoints) along a route or in an area.
Staff allocation where the changing of the perceived cost of an event and/or transition of event increases or decreases the number of staff allocated to a part of the problem. In this case, the change in cost reflects the allocation of staff and (in the case of increased cost) results in the assignment of additional staff or (in the case of decreased cost) makes staff redundant, which facilitates the reallocation of staff to other areas.
Allocating computational tasks to computational units, where the allocation of a task results in some overhead.
The allocation of individual resources to collaborative tasks, where, for example, timeliness and QoS are of importance.
Any application that requires the scheduling of a fleet of units. This includes warehousing application, logistics solutions, smart city control elements for public transport and/or other service-related scheduling.
Resource allocation applications in general (where the distance between jobs can be seen as the overhead caused by the allocation/re-allocation of jobs).
Surveillance and/or tracking applications, where either the surveillance units are mobile or where the surveillance tasks move through the areas of coverage of multiple surveillance units.
Scheduling movements for populations of aerial/amphibious units (i.e. units not restricted by route networks) in environments that are subject to change, specifically but not limited to, crisis, disaster and emergency scenarios, relief efforts, large scale humanitarian aid operations, etc.
Scheduling of mobile software agents travelling through networks and data centers.
Any other application that has a multitude of actors/agents/resources which share the handling of a multitude of jobs/tasks/calculations.
   It will be appreciated that a variety of other application contexts are also within the scope of the inventive principles discussed herein.

The task management system 101 includes a computing device, such as a server, having a processor and a non-transitory processor-readable medium (e.g., RAM, ROM, PROM, volatile, nonvolatile, or other electronic memory mechanism). The agents 103 also include a computing device, such as a vehicle telematics unit, smartphone, or other portable computing device, that also includes a processor and a non-transitory processor-readable medium. It will be appreciated that operations performed by the task management system 101 and the agents 103 are carried out according to processor-executable instructions and/or applications stored and/or installed on the non-transitory processor-readable mediums of their respective computing devices. It will further be appreciated that the task management system 101 and agents 103 include suitable communications hardware for communicating over a wireless network, for example, a cellular or landline communications network and/or wirelessly via the Internet.

In assigning tasks to the various agents (both in the initial set-up of a schedule and in modifying the schedule to account for changes such as addition, removal, or modification of tasks and/or agents), the scheduling system considers travel time associated with potential assignments of agents to particular tasks, the duration associated with each task, and each agent's capacity (e.g., the work hours or resources available to the agent). In certain embodiments, the agents may be interchangeable with one another and may be indistinguishable (such as in the case of surveillance drones monitoring an area, delivery trucks, or service engineers sent out by a utility company). In other embodiments, certain agents may be better suited for certain tasks, and the various costs associated with an agent performing a particular task may be correspondingly adjusted. For example, even if one agent is closer to a task location, another agent that incurs greater travel time costs may still be preferable to be assigned the task in view of that agent's particular expertise or that agent's capacity.

It will be appreciated that the inventive principles discussed herein are not limited to mobile agents performing geographically-distributed jobs. For example, in another exemplary context, the tasks are not associated with particular locations and/or no travel time between tasks needs to be accounted for. In such an example, the travel time cost could instead be a transition cost or could be disregarded. Nor are the inventive principles limited to contexts that require time- or order-based scheduling. Non-ordered sets of tasks, for which timing and sequence do not need to be considered, may also be assigned according to the principles discussed herein. Thus, it will be appreciated that the exemplary embodiments relating to scheduling of geographically-distributed tasks that are discussed below are merely illustrative of the inventive principles, and that the invention is not limited to this context.

Embodiments of the invention achieve scheduling efficiency by continuously optimizing the schedules of agents in response to changing conditions, and aims to maximize the individual cost-to-benefit ratio for each agent in the short-term as well as provide an overall optimal cost-to-benefit for an entire scheduling period. The changing conditions include that addition, removal, and modification of tasks, as well as the addition and removal of agents. The changing conditions may further include changing costs associated with tasks and the transitions between tasks (e.g., complications with respect to certain tasks and/or travelling to a task).

Embodiments of the invention are applicable both in continuous scheduling applications (where tasks are continuously being assigned to agents and completed by the agents sequentially or in arbitrary order without being constrained to a specific time for each task), as well as scheduling applications where specific work times are designated for tasks. When scheduling for specific work times, an optimization of the schedule can be applied to scenarios with a continuously decreasing time-frame. This considers an approaching decision horizon as well as the temporal evolution of the problem by, for example, working through a sequence of scheduled tasks and removing those that have been processed from the schedule.

Embodiments of the invention may be used to construct initial solutions, i.e. to adapt an empty set of sequential schedules to cover all tasks in a problem space, and further may be used to update the constructed schedule on-the-fly to accommodate catalyzing events (i.e., changes in tasks, agent availability, or other changes that require modification of the schedule to re-establish an optimal arrangement).

Specifically, embodiments of the invention achieve an optimal schedule by repeatedly engaging in an iterative scheduling process involving an agent cycle. A semi-stable condition is reached after a number of iterations have been performed without changes in the problem space (i.e., changes to the schedule). The semi-stable condition may be disrupted by the occurrence of a change in the problem space, to which the scheduling system adjusts, but after the adjustment is made, the system may return to the semi-stable condition.

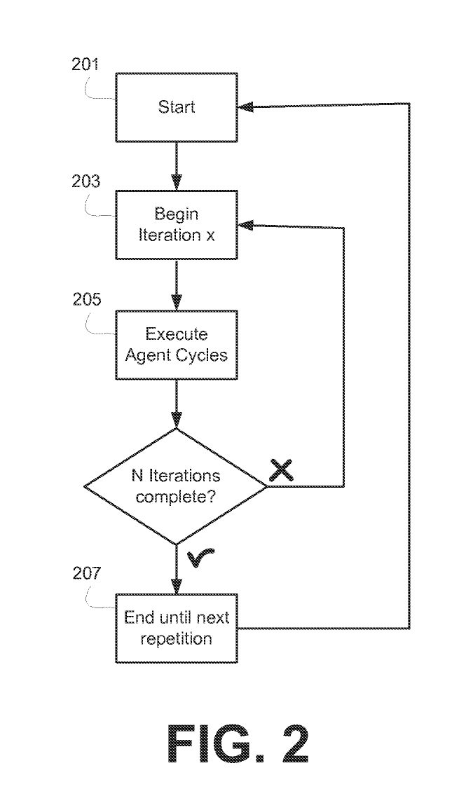

FIG. 2 depicts a flowchart that illustrates this iterative scheduling process in an exemplary embodiment. At stage 201, the scheduling process begins. At stage 203, one iteration of the process is begun. Each iteration involves executing an agent cycle for every agent, as depicted at stage 205. The order in which the agent cycles are executed may be randomly determined and the same or different for each iteration, may be a round-robin order that is the same or different for each iteration, or may be determined according to some other procedure. Using a random order that is different for each iteration may help to reduce bias relative to an embodiment where the same order is used for each iteration.

After a number of iterations N are complete, wherein an agent cycle for each agent was executed in each iteration, the process ends at stage 207. This process may be repeated often on a periodic basis (e.g., every five minutes or 20 times per second) to continually update the schedule, and/or this process may be triggered in response to a change in condition to accommodate the change (e.g., in response to a new task being added).

An example of the routine in one exemplary embodiment as described with words is provided below in pseudo-code:

For each time unit (e.g. every 5min)

For N, a number of iterations

For each agent taken in some order (random, round robin, etc)

Execute an agent cycle

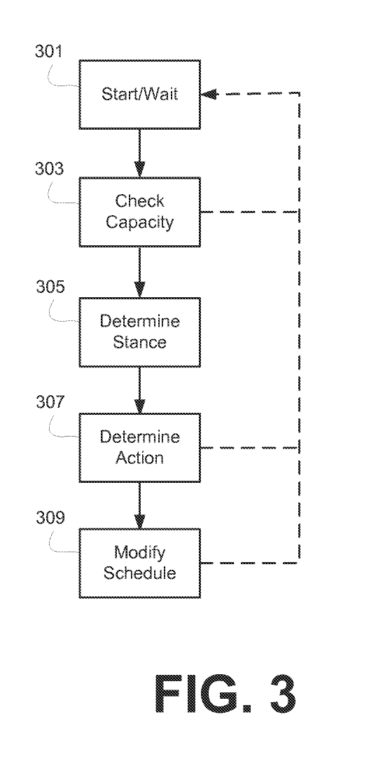

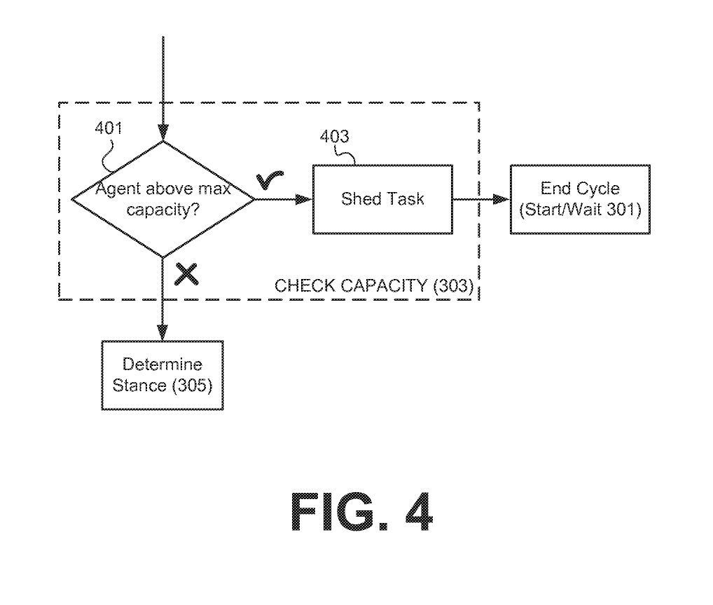

FIG. 3 depicts a flowchart that illustrates an agent cycle for a particular agent in further detail according to an exemplary embodiment. The agent cycle begins at stage 301. At stage 303, the agent (or a central scheduling system) checks the agent's capacity. If the agent is already at capacity or over capacity, the agent cycle ends and the agent (or the system) returns to stage 301 (with respect to that agent) to wait for the next agent cycle (for that agent). The agent may also shed a task if it is over capacity before the end of the cycle (which will be discussed further below with respect to FIG. 4).

If the agent does have capacity, the agent cycle continues to stage 305, where a stance is determined. Depending on which stance is determined, the scheduling procedure may try to cause tasks to be shared among agents so that they all have a similar load, or may try to take a “rich gets richer” approach to pile tasks on certain agents while freeing up other agents.

A stance-based action may be determined at stage 307, for example, having the agent for which the agent cycle is being performed capture a free task, or initiating a competition between the agent with another agent to potentially steal a task from the other agent. The schedule may then be modified accordingly at stage 309, and the agent cycle ends, with the agent (or the system) returning to stage 301 (with respect to that agent) to wait for the next agent cycle (for that agent). It is also possible that as a result of determining an action at stage 307, no action is taken and the agent cycle ends without any modification to the schedule.

In an embodiment, the two stances (balanced and maximize) are used in combination as follows. As long as all tasks are scheduled, the workload over all agents should be balanced (and so all agents are assigned the balanced stance). If tasks cannot be scheduled to any actor for a certain period of time (i.e., if any tasks remain unscheduled), agents are switched to the maximize stance to maximize their workload, which will max out the load on some actors and free capacity on others. Since all agents aim to attract tasks, unscheduled tasks will eventually become feasible for scheduling to some actor (which had to shed some load to facilitate this scheduling). With no unscheduled tasks remaining, the agents will all be returned to the balanced stance to balance the workload between themselves.

A detailed description of how the overall scheduling system operates with respect to agents being assigned to one stance or the other:
Balanced: In a comparison between the schedules of two agents, a task (previously allocated to one of the two agents) is scheduled to the agent with the lower valued schedule so as to converge towards an even workload for all agents (subject to the problem space). This will likely result in all agents having capacity to spare with an evenly distributed additional workload for all agents.
Maximize: In a comparison between the schedules of two agents, a task is scheduled to the agent for which the scheduling will result in a smaller excess capacity. If the system furthermore distinguishes between the maximum load the agent is capable of and a (somewhat lower) ideal load, this stance will allow the agents to exceed the latter (but not the former) in favor of scheduling additional task.

Through a trigger (such as an unscheduled task being available), the system can switch particular agents between the two stances so as to balance the individual workloads for the agents for acceptable solutions as well as to maximize the load of the agents. The latter will have the following effect: if two agents compete and both are trying to maximize their load, some agents will converge towards a maximal load factor, while others will be increasingly likely to lose the competition and thus shed load, thereby increasing their capacity to take on new tasks and thus enabling them to take on the costly or distant tasks previously outside their capacity.

The switching between the two approaches corresponds to a trade-off accepted by the agents: either preference is given to the optimization for an individual actor or fair allocation for multiple actors, i.e., that preference is given to optimizing/maximizing one agent's usage/performance over a scheduling that constitutes a balanced/fair allocation to all agents, or vice versa.

It will be appreciated that, in an embodiment, all of the agent cycle processing steps discussed above are implemented at a central task management computing system, such that, for example, the central system makes a determination that an agent is to shed a task and communicates it to the corresponding agent. In alternative configurations, the agents themselves may also be responsible for implementing parts of the agent cycle, such that, for example, the agent itself determines it is over capacity and decides to shed a task, and it notifies the central system accordingly such that the central system can reassign that task to another agent. In yet another further alternative implementation, no central task management computing system is used at all, and the task assignment processes are all executed in a fully distributed manner where multiple agents communicate with one another to assign, modify, and reassign tasks among one another.

In an example of the latter configurations where functionality is distributed among the central task management system and the agents or solely among the agents, each agent (e.g. a truck) may use an on-board computer, a satellite-based navigation unit (e.g., GPS unit), and a communication module. Each agent's computer maintains a copy of the tasks, and synchronization with the central system and/or other agents occurs over a communication channel established using the communication module. Decisions (e.g., determining stance and stance-based actions), task stealing, and other operations may occur using direct communication between agents, with the results being reported to the central system and/or other agents. In an example of the former configuration where functionality is centralized at the central task management system, a satellite-positioning module (e.g., a GPS unit) and a communication module are used by each agent to transfer data to the central system for all the decision-making and task-scheduling operations (such as task stealing), with the results of the operations being sent as instructions to the various agents from the central system. A communication system for the agents (e.g., truck drivers using a routing system) may be used to facilitate evaluation and carrying out of the instructions sent by the central system to the agents.

The inventive system may assign tasks to agents according to the following principles:
If all tasks are allocated to agents, agents should be assigned a “balanced” stance and share tasks, such that each agent is assigned to do a similar amount of work.
If a task has not been picked up by any agent, there exists a high likelihood that no agent had enough remaining capacity to take it. This could happen, for example, if a task is so costly (far away, long duration, etc.) that any agent that fulfills it cannot do anything else that day (e.g., a “Jumbo” task). When agents are efficiently sharing tasks, it is likely that none of them is completely free, and thus none of them will individually have the capacity to take on such a “Jumbo” task. Thus, in this situation, agents are assigned to a “maximize” stance, such that some agents taken on a disproportionate load of tasks relative to other agent(s), and those other agent(s) become completely or nearly completely free. This allows the “Jumbo” task to be assigned to one of the completely free agent(s).
After the “Jumbo” task has been assigned, the system may have a distribution where some agents are loaded with a lot of tasks while some other agents have few tasks (although some of those tasks may be very big). At this point, since all tasks have now been allocated, the agents will be assigned back to the “balanced” stance to reduce any imbalances that might have resulted from the use of the “maximize” stance.

FIG. 4 is a flowchart illustrating the process for checking capacity at stage 303 in further detail in an exemplary embodiment. At stage 401, the agent for which the agent cycle is being performed checks (or the system checks for the respective agent) whether the agent is above its max capacity. If the agent is above max capacity, then a task is shed at stage 403 and the agent returns to stage 301 (or the system returns to stage 301 with respect to that agent). If the agent is not above max capacity, the agent proceeds to stage 305 (or the system proceeds to stage 305 with respect to that agent).

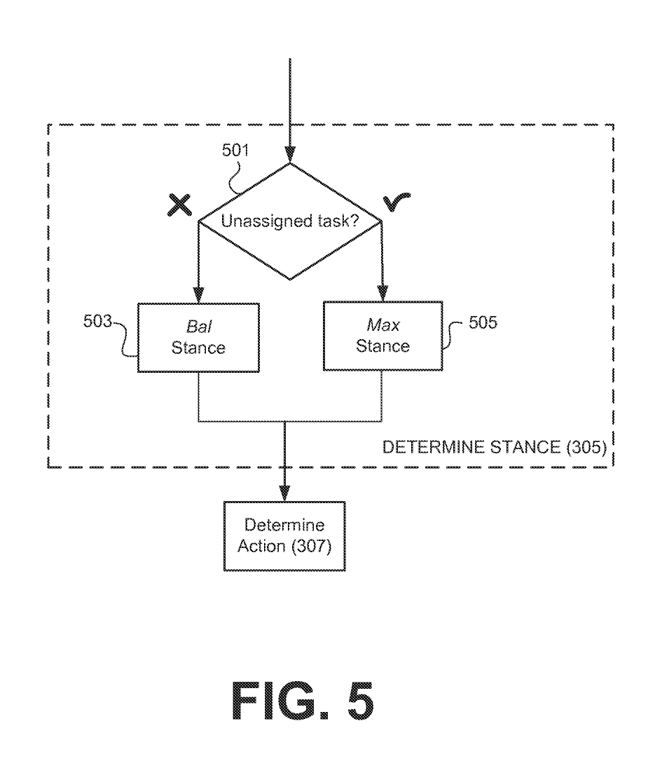

FIG. 5 is a flowchart illustrating the process for determining stance at stage 305 in further detail. At stage 501, the agent for which the agent cycle is being performed checks (or the system checks for the respective agent) whether an unscheduled task is available. In an embodiment, the determination of whether an unscheduled task is available is related to local visibility, which means that not all agents are necessarily aware of all allocated/unallocated tasks. Thus, locally-available information (such as the appearance of a new task in some locality) may affect some agents while not affecting others, causing a localized change in stance giving rise to different agent interactions (e.g., bal vs. bal, max vs. max, and bal vs. max competitions for tasks).

For example, if a new task appears, some agents will “see” this task and adopt the max stance. The remaining agents will not see the task and continue to balance their loads between themselves. The balanced agents will eventually take on some tasks from the agents that can “see” the unallocated task, thereby reducing the aggregated load shared by all “seeing” agents. The agents that can see the unallocated task will do the opposite of the balanced agents: they will either maximize their load (between themselves), or minimize it. As an example, when a new task is introduced, five agents that have 80% load could shift towards a state where four agents have 100% load and one is empty (with at least one of the five agents being placed into the maximize stance). At some time during this process, the agent with reduced load is expected to be able to pick up the unallocated task. Once this happens, all agents return to a balanced arrangement, which will, over time, result in a lowered load for all agents.

If no unscheduled tasks are available, the agent adopts or is assigned the balanced stance at stage 503. If there are one or more unscheduled tasks available, the agent adopts or is assigned the maximize stance at stage 505. The agent cycle then proceeds to stage 307 (and stage 309).

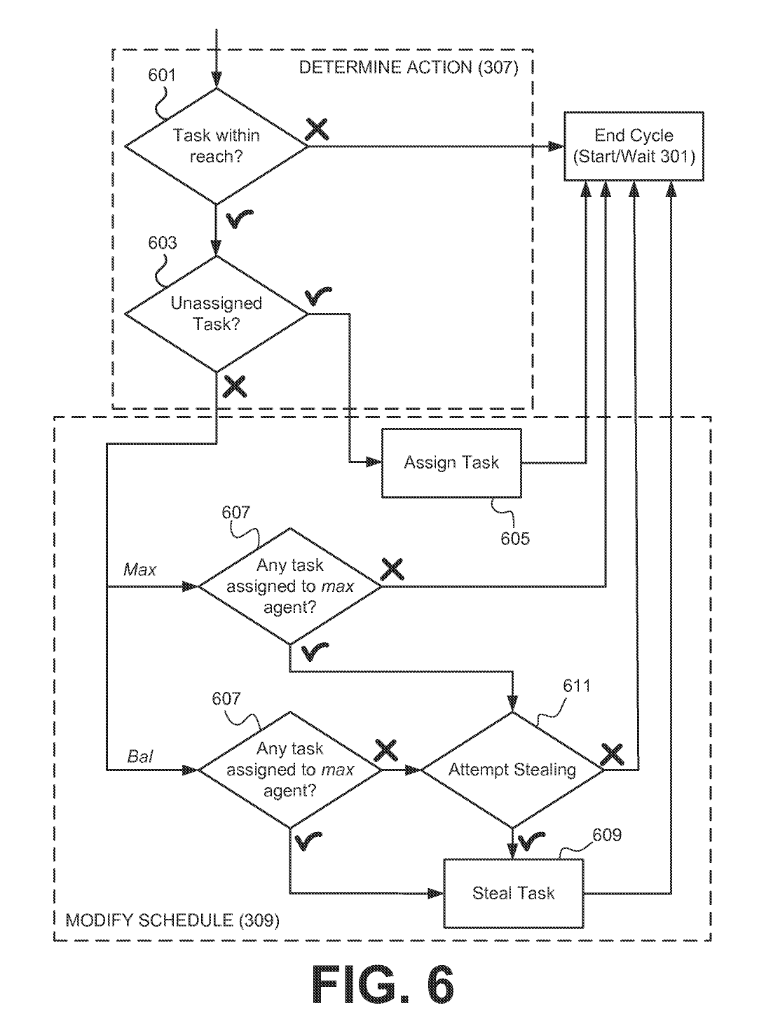

FIG. 6 is a flowchart illustrating the process for determining an action at stage 307 and modifying the schedule at stage 309 in further detail with respect to agent. At stage 601, it is determined whether there are any tasks (whether assigned to a different agent or unassigned) within reach of that agent (i.e., whether the agent has enough capacity remaining to take on any task). The consideration of whether any tasks are within reach may be different in different scenarios, for example:
In the case of scheduling trucks to deliver newspapers, for a particular truck, only those locations which it can reach given its current schedule and remaining capacity (working time, fuel, etc.) should be considered. In this case, the reachability is defined through the overall capacity of the truck and the shortest path through the current schedule as well as the new task. This is (or can be) a rather costly thing to compute (comparable to the “Traveling Salesman Problem”), and thus in this scenario it may be advantageous to use an estimation or approximation technique to determine whether a task is within reach to save on computation time.
In the case of allocating computational tasks to servers or for building tasks to be assigned to construction crews, then reachable tasks would be defined as any task which the server or construction crew can currently be expected to handle. In this case, the decision might be straight forward (i.e., a comparison of capacity to the requirements associated with the task).
In some cases, distance and requirements associated with a task may be unknown or unclear. In this situations, probabilities and known historical values may be used to venture a prediction on whether the task can be allocated to the agent. For example, the distribution and proactive dispatching of ambulances might use this definition of reachability. A specific ambulance may already earmarked for a number of potential uses while another is entirely fresh. The former might not consider an almost certain transport between two hospitals as a reachable task, while the latter would.

If no tasks are within reach of the agent, the agent returns to stage 301 (or the system returns to stage 301 with respect to that agent) and the agent cycle is ended. If there are tasks within reach, the process proceeds to stage 603 where it is determined whether any unscheduled task within reach of the agent exists. If there is an unscheduled task within reach of the agent, the task is assigned to the agent at stage 605. The process then returns to stage 301 and the agent cycle is ended with respect to that agent. It will be appreciated that certain circumstances exist where the assignment of an unscheduled task that is not within reach of the agent to the agent is allowed so as to put the agent over its maximum capacity. For example, in some implementations it might be very costly to calculate whether an agent can take on a task, and in these cases it might be cheaper (computationally speaking) to estimate whether the agent can handle a task, allocate it to the agent, and shed a task at the beginning of another cycle if the agent then determines it is over capacity.

If there are no unscheduled tasks within reach of the agent but there are one or more tasks assigned to other agents within reach of the agent, the process proceeds to stage 607, where it is determined whether there are any tasks scheduled to an agent in the max stance. The process then proceeds differently depending on whether the agent for which the agent cycle is being performed is in the balanced stance or the maximize stance (as depicted by the different “Max” and “Bal” processes in FIG. 6):
For an agent in the balanced stance, if there is a task assigned to any max stance agent, the agent in the balanced stance will steal a task from a max stance agent at stage 609. If there is no task assigned to a max stance agent, the agent in the balanced stance will attempt stealing from another agent at stage 611. This attempted stealing may or may not be successful. If it successful, the agent steals the task (stage 609) and the process returns to stage 301. If it is not successful, the agent does not steal the task and the process returns to stage 301.
For an agent in the maximize stance, if there is a task assigned to another max stance agent, the agent will attempt to steal a task from another max stance agent at stage 611. This attempted stealing may or may not be successful. If it successful, the agent steals the task (stage 609) and the process returns to stage 301. If it is not successful, the agent does not steal the task and the process returns to stage 301. If there is no task assigned to another max stance agent, no scheduling modification is made and the process returns to stage 301.

In an embodiment, the stealing (or attempted stealing) of tasks is performed with respect to one task at a time (i.e., per agent cycle). In another embodiment, one or more tasks may be stolen (or may be attempted to be stolen) per agent cycle. For example, an agent could keep trying to steal reachable tasks one after another until an attempt is successful or until some other condition occurs (e.g., the agent reaching its capacity).

In one embodiment, the choice of which task to steal (or attempt to steal) may be arbitrary or random. Using an arbitrary or random choice of task allows for the computations to advantageously be kept simple. In other embodiments, the choice of which task to steal (or attempt to steal) is based on certain considerations, such as relative proximity to the task of the agents, how close the resulting schedules would be to maximum capacity, what the change in load would be, etc. In certain scenarios, there might be one agent that is clearly better suited for a task than another (for example, a newspaper delivery truck that is much closer to a task location than another newspaper delivery truck).

The exemplary process depicted in FIG. 6 determines the winner of a competition where an agent tries to steal a task from another agent by using a comparison to determine whether a task can be scheduled for the agent (e.g., to determine whether a task is rescheduled from one mobile agent to another). In an embodiment, the math involved is intentionally kept simple (e.g., a simple comparison), and the parameters used are such that they are directly accessible by the agents. For example, the parameters are the remaining capacity of the two competing agents, and the decision is calculated using one of the formulas (or some variation thereof) in the following box (relating to the relative probability of assigning a task t to an agent A).

$$1 ) {P}_{A}^{max} = \frac{{( remaining \cdot {capacacity}_{B} )}^{α}}{{( remaining \cdot {capacacity}_{A} )}^{α} + {( remaining \cdot {capacacity}_{B} )}^{α}} ( {P}_{A}^{bal} = 1 - {P}_{A}^{max} ) with α a control parameter 2 ) {P}_{A}^{max} = \frac{{( {ideal}_{B} - {current}_{B} )}^{2 α}}{{( {ideal}_{A} - {current}_{A} )}^{2 α} + {( {ideal}_{B} - {current}_{B} )}^{2 α}} ( {P}_{A}^{bal} = 1 - {P}_{A}^{max} ) with α a control parameter ( multiplied by two to ensure that the sign of the difference between ideal and current is always positive \\ 3 ) {P}_{A}^{max} = \frac{{( C {1}_{B} + C {2}_{B} + … + {Cn}_{B} )}^{α}}{{( C {1}_{A} + C {2}_{A} + … + {Cn}_{A} )}^{α} + {( C {1}_{B} + C {2}_{B} + … + {Cn}_{B} )}^{α}} ( {P}_{A}^{bal} = 1 - {P}_{A}^{max} ) with {Ci}_{X} = {( \frac{current value of constraint i}{maximum value of constraint i} )}^{{β}_{i}} and α , {β}_{i} control parameters$$

P.max is the probability calculated for a maximization scenario while P.bal is a probability for the balanced scenario. Equation 1 is the basic case, Equation 2 makes use of the ideal workload (which can be exceeded (negative), thus the even control parameter alpha is used to ensure that the values are positive), and Equation 3 uses an arbitrary number of relevant cost parameters (to illustrate the generic applicability of the mechanism, i.e. to show that the approach can use multi-dimensional value functions). It will be appreciated that the above-listed formulas are simplified expressions relative to a practical implementation, which would likely require control parameters (added to the various elements of the formulas) to tune the calculation in a particular implementation.

These formulae can exhibit either a predisposition to favor a balanced assignment between actors (rich gets poorer) or the maximizing of the workload of the actors (rich gets richer). By calculating a probability, the process uses guided non-determinism, which makes the approach more robust and versatile. This means that sometimes the less favored agent will win a competition for a task, which helps to explore solutions that a deterministic approach would not be able to produce.

It will be appreciated that with respect to the process depicted in FIG. 6, a task being “within reach” of the agent (stage 601) means that the task could be added to the agent's schedule without exceeding the agent's maximum capacity (although in certain embodiments it may be permissible to add tasks to an agent's schedule that would cause the agent to exceed maximum capacity). It will further be appreciated that the evaluations used for attempts to modify the schedules of agents (e.g., at stages 611 and 613) considers both agents' schedules with the task potentially to be stolen included.

The exemplary embodiment discussed above illustrates scheduling in a context where agents have existing tasks scheduled. Because the adding and removing of both agents and events, situations may arise where an empty solution (i.e. an empty list of schedules) occurs. Even in such stand-alone situations, the exemplary embodiment is capable of assigning tasks in a manner that starts with an empty solution and works towards a complete scheduling. Unallocated tasks would be assigned to an agent without competition, i.e. assigned independent of the current stance of the agent.

In a further exemplary embodiment, rather than beginning FIG. 6 with the determination of whether a task is “within reach” (stage 601), the process may instead identify all agents that have tasks in their schedule that are within reach (which, in an application where the actual locations of the agents is being used, may be limited to all agents that are within a certain distance to the agent in question). The process flow would then focus on the identification of an agent to compete with first, and only afterwards would the process attempt to select a task to compete for. Since the priority is still given first to unscheduled tasks, then agents that are in the maximize stance, the process flow is still similar to that which is depicted in FIG. 6.

One way of thinking of the task management problem addressed by embodiments of the invention is as a graph (V,E) with the vertices V being tasks and E being weighted edges representing transitions between tasks. An upper limit is imposed on the number of schedules that may use a specific transition at any given time, which enables the transitions between tasks to be treated as a limited resource. In one example, this principle is implemented by increasing the cost associated with an edge in relation to the number of schedules that are currently using the edge.

In a further embodiment, only a subset of the tasks V is considered. This provides a network (e.g., a road network), and by performing an evaluation after traversing an edge, rescheduling may be achieved while in transit. For example, in the case of a service engineer using a road, a reassignment of the engineer may be performed while the engineer is in transit between two tasks.

For illustration, the scenario where trucks deliver newspapers to multiple cities is considered. In this case, there are a large number of cities (vertices) and roads that connect them (edges), with travel times as well as unloading times as costs. An optimal solution to this problem will thus have paths through the graph that connect all cities just once (or at least once, if the map requires trucks to pass through one city to get to another) in a manner that achieves minimal cost and meets time-based constraints.

In another exemplary embodiment, where an ideal load parameter is utilized in determining an optimal distribution of tasks, the ideal load parameter may be a dynamic value that is assigned a different value based on different regions, different individual agents, and/or changing circumstances (such as using a variable ideal load value that increases with the occurrence of an emergency).

It will thus be appreciated that embodiments of the invention provide a task assignment and/or scheduling system that allows for switching agents locally between stances to adapt to changing environments, which involves a combination of two separate task assignment paradigms in a manner where switching between the two paradigms is computationally inexpensive. The two paradigms may be, for example, a balanced stance that seeks to optimize a fair distribution of load across all participating agents and a maximize stance that seeks to free actors to accommodate unassigned tasks that become available. Further, the assignment of tasks in the manner provided by embodiments of the invention may take into account both a maximum length of the schedule as well as an ideal or preferred length (and to the extent that any tasks in the schedule have already been completed, the completion of such tasks is taken into account as well). The invention thus looks at the cost-to-benefit ratio achieved by various scheduling modifications, and allows for optimization over a large scale network to balance tasks (and adjust to changing conditions) in an efficient manner. This approach is robust and versatile, and is scalable to accommodate large problem spaces (as well as problem spaces that continually increase or otherwise change in size).

The embodiments of the invention facilitate a semi-steady state of a balanced workload divided between agents until the existing solution is disrupted by some change in condition. At that point, a self-determined paradigm shift occurs with respect to certain agents, which results in the co-existence of two symbiotic behaviors: agents that cannot directly work towards addressing the disruption will slowly take on the workload of those actors that can (subject to feasibility), thereby increasing the capability of the collective to address the issue. This approach is particularly advantages in applications where minor changes to the environment are expected at a continuous and frequent rate (e.g. scenarios where a large part of the solution is calculated on the basis of estimated values which are then continuously revised as real world data becomes available). Further, the combination of probabilistic decision making with this mixture of the balancing and maximizing paradigms results in the minimization of agents to which a subset of the tasks (i.e., tasks from some region of the problem space) are scheduled to. This means that under certain circumstances, some agents may have very few or no tasks scheduled, which enables them to take on tasks from other regions of the problem space. This results in the ability to effectively to reallocate actors within a problem space (even where large geographical distances exist).

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented method for assigning tasks to a plurality of agents, the method comprising:
determining, by the processor, a stance for an agent of the plurality of agents, wherein the stance is selected from the group consisting of a first stance and a second stance, wherein determining the stance is based on whether an unassigned task is available, and wherein the first stance relates to balancing tasks among the plurality of agents and the second stance relates to maximizing an amount of tasks assigned to a subset of the plurality of agents; and
when an unassigned task is available, assigning, by the processor, the unassigned task to an agent in the second stance.

2. The method of claim 1, wherein determining the stance for an agent comprises:
assigning the agent to the first stance when there are no available unassigned tasks and assigning the agent to the second stance when any unassigned task is available.

3. The method of claim 1, wherein determining the stance for the agent is part of an agent cycle, and the agent cycle further comprises:
determining that the agent is not over a maximum capacity.

4. The method of claim 1, wherein determining the stance for the agent is part of an agent cycle, and the agent cycle further comprises, for an agent in the first stance:
determining that a task is assigned to an agent in the second stance; and
stealing the task from the agent in the second stance so as to reassign the task to the agent in the first stance.

5. The method of claim 1, wherein determining the stance for the agent is part of an agent cycle, and the agent cycle further comprises, for a first agent in the first stance:
determining that no tasks are assigned to any agents in the second stance; and
attempting to steal a task from a second agent in the first stance so as to reassign the task to the first agent in the first stance if the attempt to steal is successful.

6. The method of claim 5, wherein whether the attempt to steal the task is successful is based on remaining capacities associated with the first and second agents.

7. The method of claim 5, wherein whether the attempt to steal the task is successful is based on a probabilistic calculation.

8. The method of claim 1, wherein determining the stance for the agent is part of an agent cycle, and the agent cycle further comprises, for a first agent in the second stance:
determining that a task is assigned to a second agent in the second stance; and
attempting to steal a task from the second agent in the second stance so as to reassign the task to the first agent in the second stance if the attempt to steal is successful.

9. The method of claim 1, wherein the processor that determines the stance for the agent is a processor of the agent.

10. The method of claim 1, wherein the processor that determines the stance for the agent is a processor of a centralized task management server.

11. A system for assigning tasks to a plurality of agents, the system comprising the plurality of agents, wherein the plurality of agents comprise processors and non-transitory processor-readable media having processor-executable instructions stored thereon, the processor-executable instructions, when executed, causing the following steps to be performed:
determining a stance for an agent of the plurality of agents, wherein the stance is selected from the group consisting of a first stance and a second stance, wherein determining the stance is based on whether an unassigned task is available, and wherein the first stance relates to balancing tasks among the plurality of agents and the second stance relates to maximizing an amount of tasks assigned to a subset of the plurality of agents; and
when an unassigned task is available, assigning the unassigned task to an agent in the second stance.

12. The system of claim 11, wherein determining the stance for an agent comprises:
assigning the agent to the first stance when there are no available unassigned tasks and assigning the agent to the second stance when any unassigned task is available.

13. The system of claim 11, wherein determining the stance for the agent is part of an agent cycle, and the agent cycle further comprises:
determining that the agent is not over a maximum capacity.

14. The system of claim 11, wherein determining the stance for the agent is part of an agent cycle, and the agent cycle further comprises, for an agent in the first stance:
determining that a task is assigned to an agent in the second stance; and
stealing the task from the agent in the second stance so as to reassign the task to the agent in the first stance.

15. The system of claim 11, wherein determining the stance for the agent is part of an agent cycle, and the agent cycle further comprises, for a first agent in the first stance:
determining that no tasks are assigned to any agents in the second stance; and
attempting to steal a task from a second agent in the first stance so as to reassign the task to the first agent in the first stance if the attempt to steal is successful.

16. The system of claim 15, wherein whether the attempt to steal the task is successful is based on remaining capacities associated with the first and second agents.

17. The system of claim 15, wherein whether the attempt to steal the task is successful is based on a probabilistic calculation.

18. The system of claim 11, wherein determining the stance for the agent is part of an agent cycle, and the agent cycle further comprises, for a first agent in the second stance:
determining that a task is assigned to a second agent in the second stance; and
attempting to steal a task from the second agent in the second stance so as to reassign the task to the first agent in the second stance if the attempt to steal is successful.

19. A system for assigning tasks to a plurality of agents, the system comprising a server and the plurality of agents, wherein the server and the plurality of agents comprise processors and non-transitory processor-readable media having processor-executable instructions stored thereon, the processor-executable instructions, when executed, causing the following steps to be performed:
determining a stance for an agent of the plurality of agents, wherein the stance is selected from the group consisting of a first stance and a second stance, wherein determining the stance is based on whether an unassigned task is available, and wherein the first stance relates to balancing tasks among the plurality of agents and the second stance relates to maximizing an amount of tasks assigned to a subset of the plurality of agents; and
when an unassigned task is available, assigning the unassigned task to an agent in the second stance.
